(19) United States
(12) Patent Application Publication
(10) Pub. No.: US 2022/0356975 A1
(43) Pub. Date: Nov. 10, 2022

(54) Waste Pipe Fitting Assembly

(71) Applicants: Douglas Murray, Rye Brook, NY (US); Stacey Murray, Rye Brook, NY (US)

(72) Inventors: Douglas Murray, Rye Brook, NY (US); Stacey Murray, Rye Brook, NY (US)

(21) Appl. No.: 17/313,061

(22) Filed: May 6, 2021

(51) Int. Cl. F16L 41/02; F16L 3/127; F16L 55/11

(52) U.S. Cl. CPC F16L 41/021; F16L 3/127; F16L 55/1141

(57) ABSTRACT

A waste pipe fitting assembly includes a tee wye fitting that has an outlet, a first inlet and a second inlet. The outlet is fluidly connectable to a sewer line of a sewer system. The second inlet is fluidly connectable to a drain pipe to place the drain pipe in fluid communication with the sewer line thereby draining water from the drain pipe into the sewer line. A pair of hangers is each of the hangers is coupled to the tee wye fitting and each of the hangers engages a respective support for suspending the tee wye fitting from the supports. Moreover, each of the hangers engages the respective support at an adjustable height to inhibit fluid from collecting in the tee wye fitting.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fitting device and more particularly pertains to a new fitting device for facilitating a tee wye fitting to be installed at a desired angle. The device includes a tee wye fitting and a pair of hangers that are integrated into the tee wye fitting. Each of the hangers engages a support to suspend the tee wye fitting at a desired angle on the supports.

### (2) Description of Related Art Including Information Disclosed Under 37 CFR 1.97 and 1.98

The prior art relates to fitting devices including a variety of tee wye fittings for plumbing into a sewer system. In no instance does the prior art disclose a tee wye fitting that has hangers integrated therein for suspending the tee wye fitting from supports.

### BRIEF SUMMARY OF THE INVENTION

An embodiment of the disclosure meets the needs presented above by generally comprising a tee wye fitting that has an outlet, a first inlet and a second inlet. The outlet is fluidly connectable to a sewer line of a sewer system. The second inlet is fluidly connectable to a drain pipe to place the drain pipe in fluid communication with the sewer line thereby draining water from the drain pipe into the sewer line. A pair of hangers is each of the hangers is coupled to the tee wye fitting and each of the hangers engages a respective support for suspending the tee wye fitting from the supports. Moreover, each of the hangers engages the respective support at an adjustable height to inhibit fluid from collecting in the tee wye fitting.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a waste pipe fitting assembly according to an embodiment of the disclosure.

FIG. 2 is a perspective in-use view of an embodiment of the disclosure.

FIG. 3 is a front view of an embodiment of the disclosure.

FIG. 4 is a back view of an embodiment of the disclosure.

FIG. 5 is a bottom view of an embodiment of the disclosure.

FIG. 6 is a perspective in-use view of an embodiment of the disclosure showing a tee wye fitting being plumbed between a feed pipe and a sewer line.

### DETAILED DESCRIPTION OF THE INVENTION

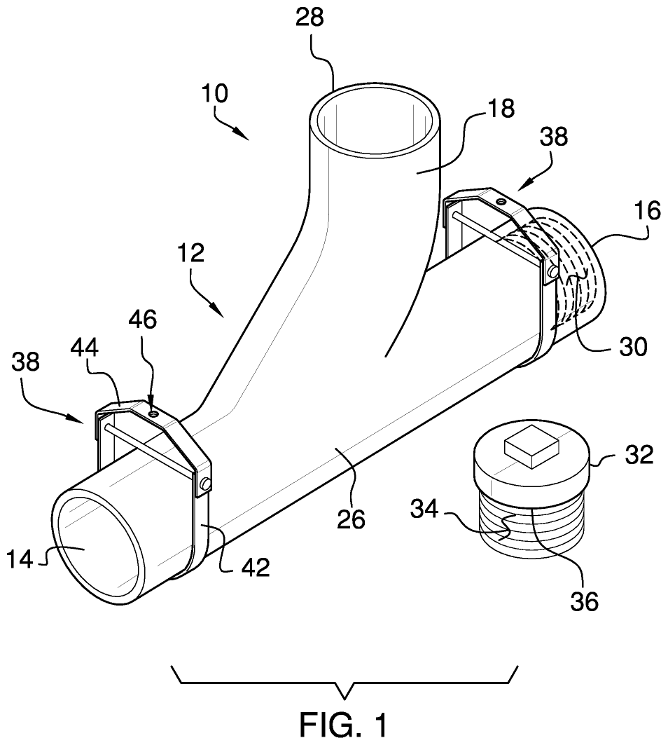

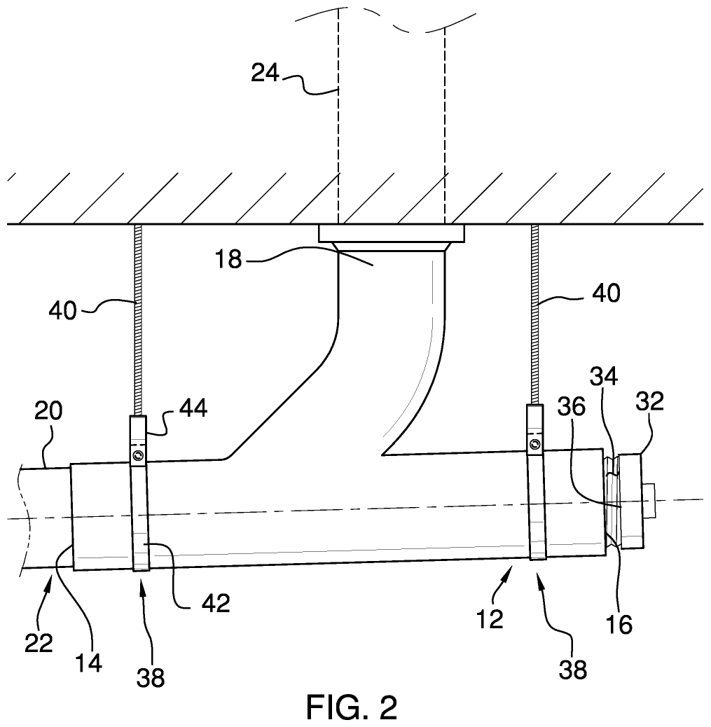

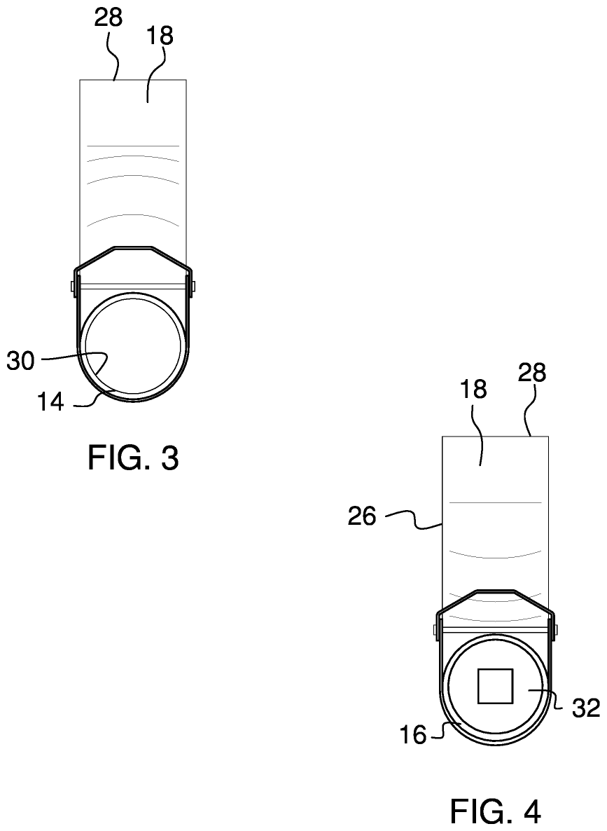

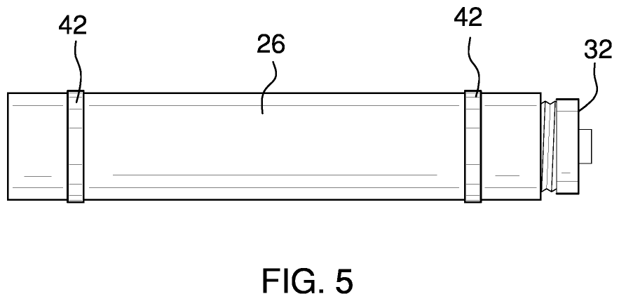

With reference now to the drawings, and in particular to FIGS. 1 through 6 thereof, a new fitting device embodying the principles and concepts of an embodiment of the disclosure and generally designated by the reference numeral 10 will be described.

As best illustrated in FIGS. 1 through 6, the waste pipe fitting assembly 10 generally comprises a tee wye fitting 12 that has an outlet 14, a first inlet 16 and a second inlet 18. The outlet 14 is fluidly connectable to a sewer line 20 of a sewer and/or storm drain system 22. The sewer and/or storm drain system 22 may be a sewer and/or storm drain system in a building, such as an office building, a residential building, or other similar type of occupancy. The second inlet 18 is fluidly connectable to a drain pipe 24 to place the drain pipe 24 in fluid communication with the sewer line 20 for draining water from the drain pipe 24 into the sewer line 20.

The tee wye fitting 12 has an outer wall 26 extending between the outlet 14 and the first inlet 16. The second inlet 18 curves upwardly from the outer wall 26 such that the second inlet 18 has a direction of flow that is oriented perpendicular to a direction of flow between the first inlet 16 and the outlet 14. The second inlet 18 has a distal end 28 with respect to the outer wall 26 and the distal end 28 fluidly engages the drain pipe 24. The second inlet 18 curves rearwardly toward the first inlet 16, the outer wall 26 has an inside surface 30 and the inside surface 30 is threaded adjacent to the first inlet 16.

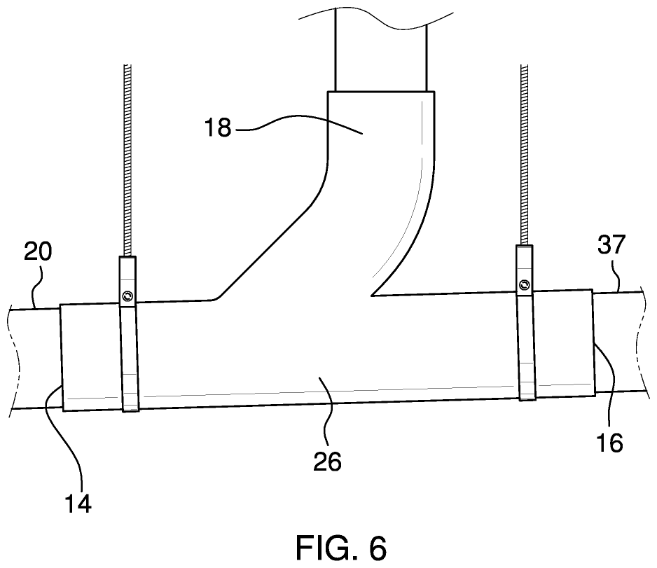

A plug 32 is provided that is attachable to the tee wye fitting 12 having the plug 32 closing the first inlet 16 to inhibit fluid from passing through the first inlet 16. The plug 32 has an outer surface 34, the outer surface 34 is threaded and the outer surface 34 threadably engages the inner surface 30 of the outer wall 26 of the tee wye fitting 12 for retaining the plug 32 in the first inlet 16. The plug 32 has a first surface 36 that is oriented perpendicular to the outer surface 34. The first surface 36 is compressed against the first inlet 16 when the plug 32 is tightened into the first inlet 16. As is most clearly shown in FIG. 6, a feed pipe 37 may be fluidly coupled to the first inlet 16 such that the tee wye fitting 12 facilitates water to flow from the feed pipe 37 into the sewer line 20. The feed pipe 37 may receive waste water from plumbing fixtures in the building.

A pair of hangers 38 is each coupled to the tee wye fitting 12 and each of the hangers 38 engages a respective support 40 for suspending the tee wye fitting 12 from the supports 40. Each of the hangers 38 engages the respective support 40 at an adjustable height thereby facilitating the tee wye fitting 12 to be oriented at a variety of angles according to applicable plumbing codes. In this way the tee wye fitting 12 inhibits fluid from collecting in the tee wye fitting 12. The respective support 40 may be a threaded rod or screw. Each of the hangers 38 comprises a saddle 42 and a bracket 44 that is pivotally coupled to the saddle 42. The saddle 42 cradles the outer wall 26 of the tee wye fitting 12 such that the bracket is spaced from the outer wall 26. The bracket 44 associated with each of the hangers 38 has a hole 46 extending through the bracket 44 for insertably receiving the support 40. Additionally, the saddle 42 associated with each of the hangers 38 is positioned adjacent to a respective one of the first inlet 16 and the outlet 14.

In use, the tee wye fitting 12 is plumbed into the sewer line 20 to fluidly attach the drain pipe 24 to the sewer line 20. Each of the hangers 38 is engaged to the respective support 40 and the hangers 38 is positioned on the supports 40 to orient the tee wye fitting 12 at an appropriate angle to inhibit fluid from collecting in the tee wye fitting 12. In this way the tee wye fitting 12 is inhibited from being ruptured due to fluid freezing inside the tee wye fitting 12. Additionally, the hangers 38 fully support the tee wye fitting 12 thereby inhibiting the tee wye fitting 12 from becoming dislodged and falling, potentially injuring a person. The plug 32 is removable from the tee wye fitting 12 to facilitate the tee wye fitting 12 and the sewer line 20 to be cleaned out if necessary.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A waste pipe fitting assembly for fitting a drain pipe to a sewer system, said assembly comprising:
a tee wye fitting having an outlet, a first inlet and a second inlet, said outlet being fluidly connectable to a sewer line of a sewer system, said second inlet being fluidly connectable to a drain pipe wherein said tee wye fitting is configured to place the drain pipe in fluid communication with the sewer line for draining water from the drain pipe into the sewer line;
a plug being attachable to said tee wye fitting having said plug closing said first inlet wherein said plug is configured to inhibit fluid from passing through said first inlet; and
a pair of hangers, each of said hangers being coupled to said tee wye fitting, each of said hangers engaging a respective support for suspending said tee wye fitting from the supports, each of said hangers engaging the respective support at an adjustable height thereby facilitating said tee wye to be oriented at an angle wherein said tee wye fitting is configured to inhibit fluid from collecting in said tee wye fitting.

2. The assembly according to claim 1, wherein said tee wye fitting has an outer wall extending between said outlet and said first inlet, said second inlet curving upwardly from said outer wall such that said second inlet has a direction of flow being oriented perpendicular to a direction of flow between said first inlet and said outlet, said second inlet having a distal end with respect to said outer wall wherein said distal end is configured to fluidly engage the drain pipe, said second inlet curving rearwardly toward said first inlet.

3. The assembly according to claim 2, wherein:
said outer wall has an inside surface, said inside surface being threaded adjacent to said first inlet; and
said plug has an outer surface, said outer surface being threaded, said outer surface threadably engaging said inner surface of said outer wall of said tee wye fitting for retaining said plug in said first inlet, said plug having a first surface being oriented perpendicular to said outer surface, said first surface being compressed against said first inlet when said plug is tightened into said first inlet.

4. The assembly according to claim 2, wherein each of said hangers comprises a saddle and a bracket being pivotally coupled to said saddle, said saddle cradling said outer wall of said tee wye fitting, each of said brackets having a hole extending through said brackets for insertably receiving the support, said saddle associated with each of said hangers being positioned adjacent to a respective one of said first inlet and said outlet.

5. A waste pipe fitting assembly for fitting a drain pipe to a sewer system, said assembly comprising:
a tee wye fitting having an outlet, a first inlet and a second inlet, said outlet being fluidly connectable to a sewer line of a sewer system, said second inlet being fluidly connectable to a drain pipe wherein said tee wye fitting is configured to place the drain pipe in fluid communication with the sewer line for draining water from the drain pipe into the sewer line, said tee wye fitting having an outer wall extending between said outlet and said first inlet, said second inlet curving upwardly from said outer wall such that said second inlet has a direction of flow being oriented perpendicular to a direction of flow between said first inlet and said outlet, said second inlet having a distal end with respect to said outer wall wherein said distal end is configured to fluidly engage the drain pipe, said second inlet curving rearwardly toward said first inlet, said outer wall having an inside surface, said inside surface being threaded adjacent to said first inlet;
a plug being attachable to said tee wye fitting having said plug closing said first inlet wherein said plug is configured to inhibit fluid from passing through said first inlet, said plug having an outer surface, said outer surface being threaded, said outer surface threadably engaging said inner surface of said outer wall of said tee wye fitting for retaining said plug in said first inlet, said plug having a first surface being oriented perpendicular to said outer surface, said first surface being compressed against said first inlet when said plug is tightened into said first inlet; and
a pair of hangers, each of said hangers being coupled to said tee wye fitting, each of said hangers engaging a respective support for suspending said tee wye fitting from the supports, each of said hangers engaging the respective support at an adjustable height thereby facilitating said tee wye to be oriented at an angle wherein said tee wye fitting is configured to inhibit fluid from collecting in said tee wye fitting, each of said hangers comprising a saddle and a bracket being pivotally coupled to said saddle, said saddle cradling said outer wall of said tee wye fitting, each of said brackets having a hole extending through said brackets for insertably receiving the support, said saddle associated with each of said hangers being positioned adjacent to a respective one of said first inlet and said outlet.
